(19) United States
(12) Patent Application Publication
(10) Pub. No.: US 2017/0072721 A1
(43) Pub. Date: Mar. 16, 2017

(54) INK JET PRINTER

(71) Applicant: Seiko Epson Corporation, Shinjuku-ku (JP)

(72) Inventors: Haruki KOBAYASHI, Shiojiri-shi (JP); Isamu TOGASHI, Matsumoto-shi (JP); Taiki HANAGAMI, Matsumoto-shi (JP)

(21) Appl. No.: 15/360,546

(22) Filed: Nov. 23, 2016

Related U.S. Application Data
(62) Division of application No. 14/749,485, filed on Jun. 24, 2015.

(30) Foreign Application Priority Data
Jun. 26, 2014 (JP) 2014-130916

(51) Int. Cl. B41J 25/00; B41J 2/145

(52) U.S. Cl. CPC B41J 25/006; B41J 2/145

(57) ABSTRACT

Provided is an ink jet printer including an ink jet head that has a nozzle surface on which nozzles for ejecting liquid are open; and a carriage on which the ink jet head is mounted, in which the carriage is scanned from one end at which a scanning reference point of the carriage is set to the other end via an area through which a liquid impacted object passes, the ink jet head is mounted to the carriage in a state of being deviated to one end in a scanning direction from a center of the carriage in the scanning direction, and a space is provided on a lateral side at the other end of the ink jet head in the carriage by deviating the ink jet head to the carriage.

### CROSS REFERENCE TO RELATED APPLICATIONS

This application is a continuation of U.S. patent application Ser. No. 14/749,485, filed Jun. 24, 2015, which claims priority to Japanese Patent Application No. 2014-130916, filed Jun. 26, 2014, the entire disclosures of which are all incorporated by reference herein.

### BACKGROUND

1. Technical Field

The present invention relates to an ink jet printer such as an ink jet recording device, and particularly to an ink jet printer in which further miniaturization can be achieved.

2. Related Art

An ink jet printer which is a kind of a liquid ejecting apparatus is an apparatus that includes a permanent head and ejects (discharges) various kinds of liquid from the permanent head. The ink jet printer is a non-impact printer, in which text is formed by ejection of particles or small droplets of ink on paper (JIS X0012-1990). The ink jet printer is an embodiment of the dot printer which is a printer that prints a text or an image expressed by plural dots (JIS X0012-1990), and prints text or images expressed by plural dots formed by ejection of particles or small droplets of ink. In addition, the permanent head is a machine portion or an electric portion of the main body of the printer, which continuously or intermittently generates droplets of ink (hereinafter, referred to as an “ink jet head”) (JIS Z8123-1:2013). In addition to being used as an image recording apparatus, by using a characteristic of enabling a very small amount of liquid to be accurately ejected to a predetermined position, the ink jet printer is applied to various manufacturing apparatuses. For example, the ink jet printer is applied to a display manufacturing apparatus for manufacturing a color filter such as a liquid crystal display, an electrode forming apparatus for forming electrodes such as an organic electro luminescence (EL) display or field emission display (FED), and a chip manufacturing apparatus for manufacturing a biochip (biochemical element). Also, the recording head for the image recording apparatus ejects liquid ink, and a coloring material ejecting head for a display manufacturing apparatus ejects solutions of respective coloring materials of red (R), green (G), and blue (B). In addition, an electrode material ejecting head for an electrode forming apparatus ejects liquid electrode materials, and a biological organic member ejecting head for a chip manufacturing apparatus ejects liquid as a biological organic member.

In the ink jet printer, the ink jet head (recording head) which is a kind of liquid ejecting head is mounted on the carriage, and ink is ejected from nozzles of a recording head while a carriage is caused to scan a recording paper in the paper width direction which is a printing object transported to a support stand called a platen so that an image or the like is recorded (printed) on recording paper or the like. In such a printer, in addition to the carriage or the support stand, a mechanism for causing the carriage (recording head) to perform scanning, a mechanism for transporting the printing object such as recording paper, and a maintenance mechanism for performing maintenance of the recording head, or the like is provided in the housing (for example, see JP-A-2007-245386).

Recently, an ink jet printer that is small and easy to carry has been developed. In such an ink jet printer, it is preferable to lay out components as effectively as possible while the miniaturization of the overall apparatus is achieved, and also to suppress useless space.

### SUMMARY

An advantage of some aspects of the invention is to provide an ink jet printer in which useless space is reduced and the miniaturization of the overall apparatus is achieved.

According to an aspect of the invention, there is provided an ink jet printer including: an ink jet head that has a nozzle surface on which nozzles for ejecting liquid are open; and a carriage on which the ink jet head is mounted, in which the carriage is scanned from one end at which a scanning reference point of the carriage is set to the other end via an area through which a liquid impacted object passes, the ink jet head is mounted to the carriage in a state of being deviated to one end in a scanning direction from a center of the carriage in the scanning direction, and a space is provided on a lateral side at the other end of the ink jet head in the carriage by deviating the ink jet head to the carriage.

According to the invention, if the ink jet head is deviated to one end in a scanning direction from the center of the carriage in the scanning direction, narrow areas (dead spaces) respectively generated on both sides of the ink jet head in the carriage in the related art can be set to be one united space on the lateral side at the other end of the ink jet head so that the corresponding space can be effectively used, for example, by arranging another member in the corresponding space. In addition, if the ink jet head is deviated to one end in a scanning direction from a center of the carriage in the scanning direction, other members in the apparatus can be entirely deviated to one end in the carriage scanning direction so as to contribute to the miniaturization of the whole body of the printer.

In this case, it is preferable that a maintenance mechanism that performs maintenance of the ink jet head is arranged at a position that faces a nozzle surface of the ink jet head positioned at the scanning reference point.

According to the configuration, the maintenance mechanism can be arranged so as to be deviated to one end side in the carriage scanning direction, so that dead space on the lateral side generated on one side of the maintenance mechanism can be reduced.

In this case, it is preferable that a component of a mechanism relating to transportation of the impacted object is arranged on the other side in the scanning direction, and at least a portion of the component enters the space on the lateral side of the ink jet head positioned at the other end.

According to the configuration described above, if the ink jet head is deviated to one end side in the scanning direction with respect to the carriage, a component that is concerned to intervene with the ink jet head is arranged at the other end, and at least a portion of the corresponding component in a state in which the ink jet head is positioned at the other end is caused to enter the space on the lateral side of the ink jet head, so that the corresponding space can be effectively used and the deviation can contribute to the further miniaturization of the apparatus.

In this case, it is preferable that a detection apparatus that detects an end portion of the impacted object is arranged in the space.

According to the configuration, if the detection apparatus is arranged in a space on the lateral side of the ink jet head, a space for arranging the detection apparatus may not be separately provided, and the arrangement can contribute to the miniaturization of the apparatus.

In this case, it is preferable that a connector to which wiring relating to driving of the ink jet head is connected is arranged in the space.

According to the configuration, a connector that relatively significantly occupies a space in the apparatus is arranged in the space of the ink jet head on the lateral side so that the arrangement can contribute to the miniaturization of the apparatus.

### BRIEF DESCRIPTION OF THE DRAWINGS

The invention will be described with reference to the accompanying drawings, wherein like numbers reference like elements.

FIG. 1 is a perspective view illustrating a configuration of an external appearance of a printer.

FIG. 2 is a plan view illustrating an internal configuration of the printer.

FIG. 3 is a cross-sectional view taken along line in FIG. 2.

FIG. 4 is a cross-sectional view taken along line IV-IV in FIG. 2.

FIG. 5 is an exploded perspective view illustrating a configuration of a recording head.

FIG. 6 is a top view illustrating the configuration of the recording head.

FIG. 7 is a bottom view illustrating the configuration of the recording head.

FIG. 8 is a cross-sectional view illustrating a main section in the configuration of the recording head.

FIG. 9 is an exploded perspective view illustrating a configuration of a channel unit.

FIG. 10 is a plan view illustrating a configuration of a carriage.

### DESCRIPTION OF EXEMPLARY EMBODIMENTS

Hereinafter, embodiments for performing the invention are described with respect to the accompanying drawings. In addition, in the embodiments described below, various limitations are provided, but the scope of the invention is not limited thereto, if not described otherwise. In addition, hereinafter, as an ink jet printer according to the invention, for example, an ink jet type image recording apparatus (hereinafter, simply referred to as “printer”) is described.

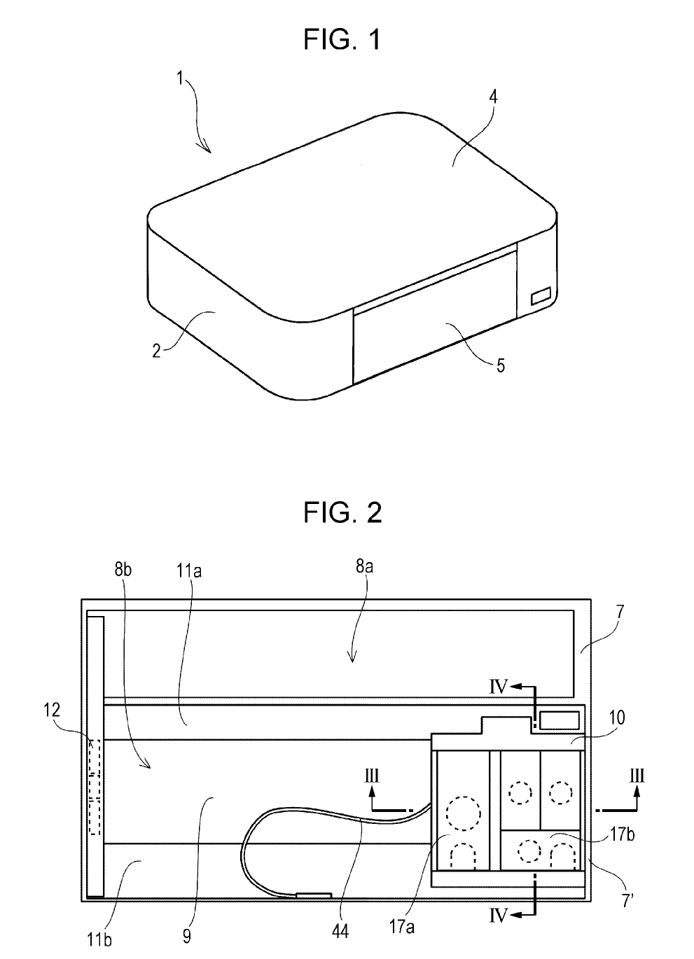

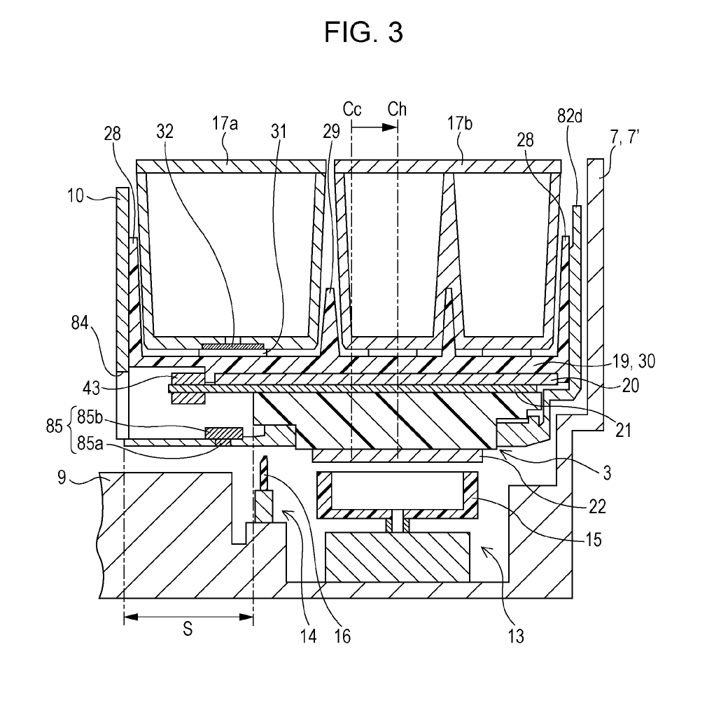

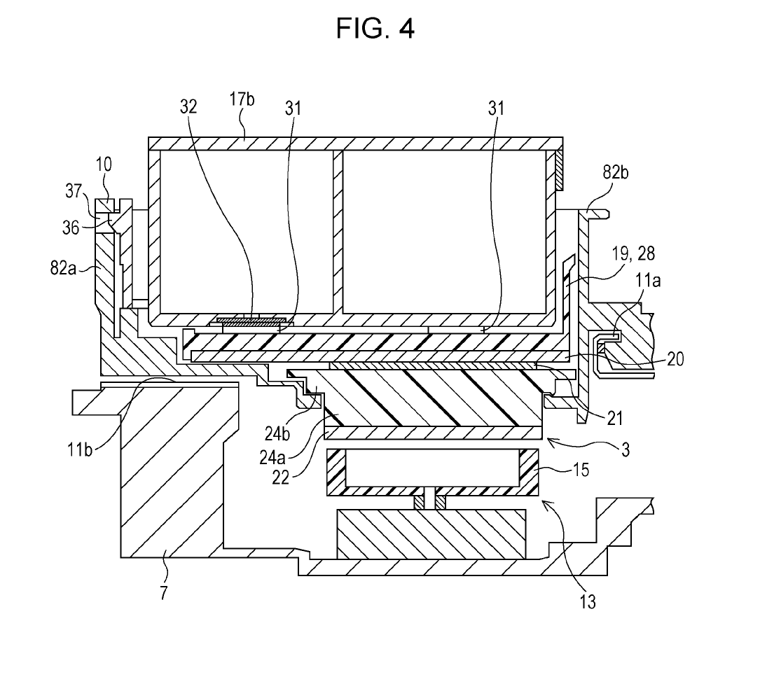

FIG. 1 is a perspective view illustrating an external configuration of a printer 1, and FIG. 2 is a plan view illustrating an internal configuration of the printer 1. In addition, FIG. 3 is a cross-sectional view taken along line in FIG. 2, and FIG. 4 is a cross-sectional view taken along line IV-IV in FIG. 2. The printer 1 according to the embodiment includes an ink jet type recording head (hereinafter, referred to as a “recording head 3”) which is a kind of ink jet head and which is mounted on a carriage 10 in a housing 2 of the main body of the printer. The printer 1 can print a photograph image, text, or the like on recording paper or the like by ejecting ink from nozzles 63 of the recording head 3 onto recording paper, a postcard, or the like (a kind of recording paper or a liquid impacted object). A body cover 4 is provided on the upper surface side of the housing 2. The body cover 4 raises a margin portion of the housing 2 on the front surface side to rotate a margin portion on the housing 2 on the rear surface side about an axis so that the upper surface of the housing 2 can be released. In a state in which the body cover 4 is opened, the exchange work of ink cartridges 17, or the like is performed. In addition, a discharge tray 5 is provided on the lower side of the front surface of the housing 2. The discharge tray 5 can be opened by being rotated to the front about a lower edge side as an axis, so that printed recording paper or the like is discharged onto the discharge tray 5. In addition, recording paper, a postcard, or the like can be set on the rear surface side of the housing 2.

The inner portion of the housing 2 is partitioned by a metal body frame 7, into a paper feeding portion 8a that is a partition in which a paper feeding mechanism (not illustrated) that feeds recording paper or the like to a platen 9 side is provided and a printing portion 8b which is a partition in which printing (recording operation) is performed by the recording head 3 to recording paper fed to the platen 9. The platen 9 is a support stand that supports recording paper while printing is performed, and the upper surface thereof according to the invention corresponds to an area through which an impacted object passes. Guide frames 11a and 11b are provided in parallel each other on the rear surface and the front surface of the printing portion 8b of the body frame 7 in the longitudinal direction of the housing 2. The carriage 10 is supported by the guide frames 11a and 11b in the frontward and rearward direction. The carriage 10 is guided along the guide frames 11a and 11b by a driving force caused by a driving motor (not illustrated), so that the carriage 10 can reciprocate.

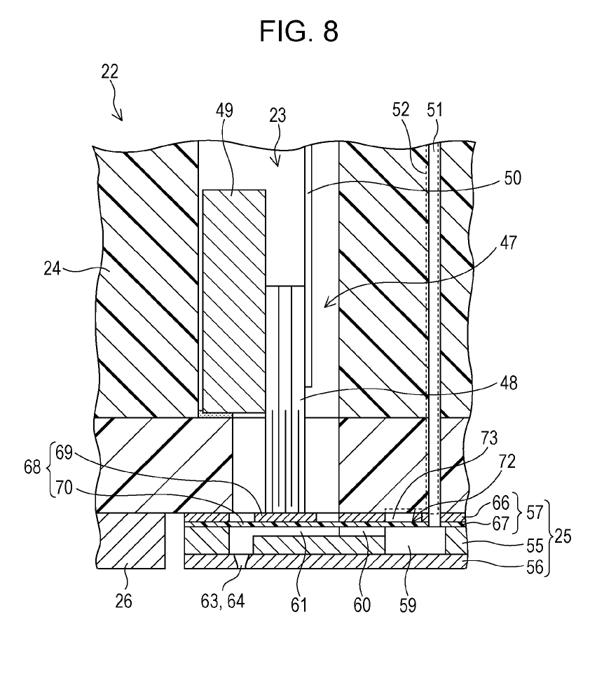

On one side of the movement range of the carriage 10 (right side in FIG. 2), a home position that is a stand-by position of the recording head 3 in a state in which a recording operation is not performed and that corresponds to a scanning reference point according to the invention is provided. In the home position, a capping mechanism 13 (a kind of a maintenance mechanism according to the invention) and a wiping mechanism 14 (wiping section) are provided sequentially from one end side (a portion close to a sidewall 7′ on one end side of the body frame 7). The capping mechanism 13 has, for example, a cap 15 formed of an elastic member such as elastomer, so that the cap 15 can be switched into a state of being sealed by being brought into contact with a nozzle surface of the recording head 3 (or a head cover 26 provided to surround the nozzle surface (see FIGS. 7 and 8)) (capping state) or a retracted state of being separated from the head cover 26. In the capping state, the capping mechanism 13 can depressurize the inside of the cap 15 with a pump (not illustrated), and thus can perform a cleaning operation of discharging ink or bubbles from the nozzles 63 of the recording head 3. On the other end side which is on the opposite side of the home position in the movement range of the carriage 10 (left side in FIG. 2), a driving component 12 relating to the transportation of recording paper on the platen 9 is installed to be adjacent to the platen 9. Specifically, the driving component 12 includes a driving gear or the like that transmits the driving force of the motor for transporting recording paper to a transporting roller or the like.

The wiping mechanism 14 wipes the nozzle surface of the recording head 3 with a wiper 16, and can be switched to be in a state in which the wiper 16 is brought into contact with a nozzle surface or a retracted state in which the wiper 16 is separated from the nozzle surface. As the wiper 16, various kinds of wipers can be employed, but, for example, a wiper in which a water repellent film is formed of a resin on the surface of a main body of a blade or a cloth wiper formed in which a portion coming into contact with the nozzle surface is formed of cloth can be employed. In the embodiment, in a state in which the wiper 16 comes into contact with the nozzle surface of the recording head 3, the carriage 10 moves in a main scanning direction, so that the wiper 16 slides and wipes the nozzle surface. In addition, in a state in which the recording head 3 stops moving, the wiper 16 is driven by itself so that the nozzle surface can be wiped. In short, the wiping mechanism 14 may have a configuration in which the recording head 3 and the wiper 16 move relative to each other such that the nozzle surface is wiped.

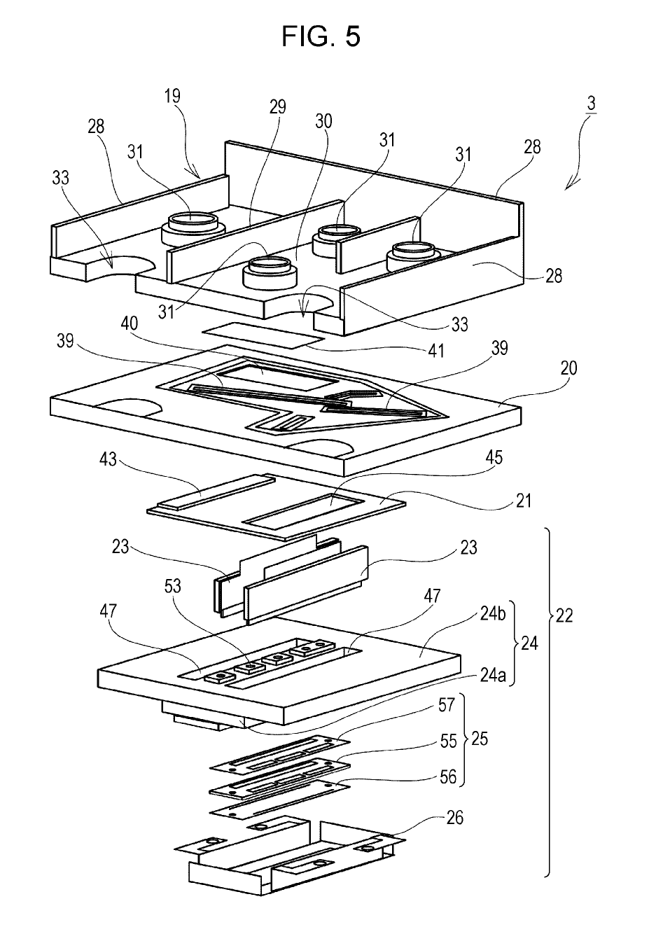

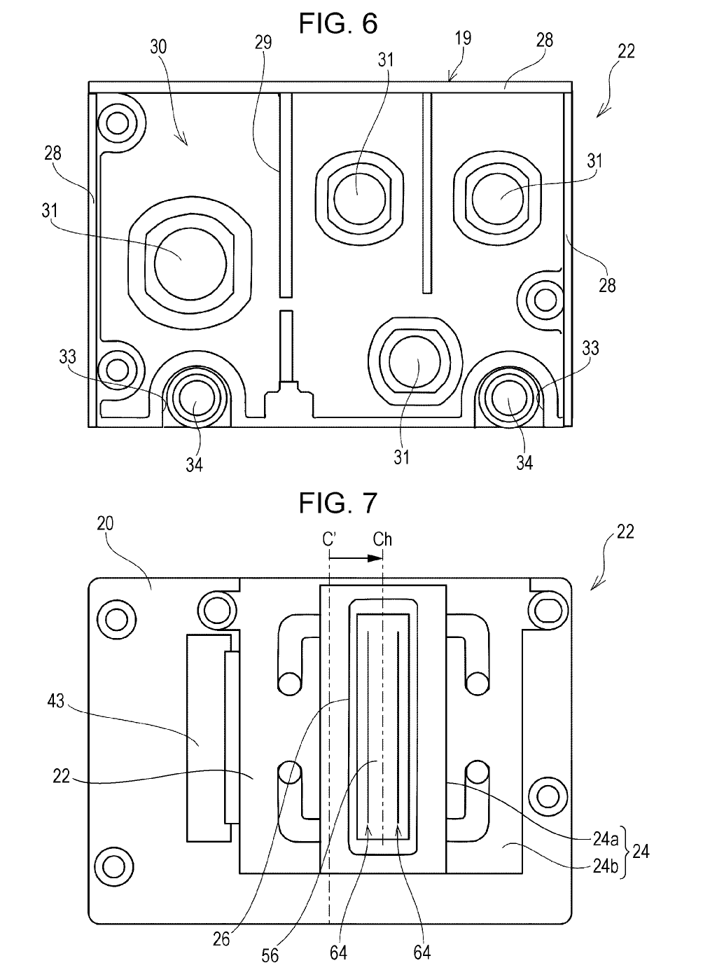

FIG. 5 is an exploded perspective view illustrating a configuration of the recording head 3. In addition, FIG. 6 is a top view (plan view) illustrating a configuration of the recording head 3, and FIG. 7 is a bottom view illustrating a configuration of the recording head 3. Further, FIG. 8 is a cross-sectional view illustrating a main section of the internal configuration of the recording head 3. The recording head 3 according to the embodiment includes a holder 19, a channel plate 20, a circuit substrate 21, and a head unit 22 as a head component. In addition, the head unit 22 includes an oscillator unit 23, a head case 24, a channel unit 25, and the head cover 26, as a head unit component.

The holder 19 is a member manufactured with a synthetic resin, and includes a base plate 30 and exterior walls 28 which are upwardly provided on both the left and right sides of the base plate 30 in the lateral direction (in the scanning direction of the carriage 10) and on the rearward side in the frontward and rearward direction (transportation direction of recording paper or the like). In addition, the upper surface of the base plate 30 is partitioned by a partition wall 29 provided on the inner side of the exterior walls 28, into an arrangement area for a black ink cartridge 17a (area on the left side of the partition wall 29 in FIG. 6) and an arrangement area for a color ink cartridge 17b (area on the right side of the partition wall 29 in FIG. 6). Ink introducing portions 31 are provided on the respective cartridge arrangement areas. The ink introducing portions 31 are portions connected to ink outlet portions 32 of the ink cartridges 17, and are provided for each color of the ink. According to the embodiment, corresponding to the four colors of the ink: black ink, cyan ink, magenta ink, and yellow ink, four ink introducing portions 31 in total are provided. The ink introducing portions 31 have filters (not illustrated) and porous members (liquid absorbing material) in openings in cylindrical portions. In addition, the porous members are provided in the ink outlet portions 32 of the ink cartridges 17, and, if the ink outlet portions 32 and the ink introducing portions 31 are connected, porous members come into contact with each other so that the ink can be sent and received. If the ink is introduced from the ink introducing portions 31, the ink is filtered by the filters, and supplied to the head unit 22 via intermediate channels 39 of the channel plate 20 described below.

Notches 33 which are substantially semicircular in a plan view are provided in a margin portion on the front side of the base plate 30 in the holder 19. The notches 33 are hollow portions in which energizing members 34 formed of coil springs are arranged. The lower surfaces of the notches 33 are blocked by the channel plate 20, and the energizing members 34 are installed on the blocked portions. In a state in which the ink cartridges 17 are mounted on the holder 19, and engaging claws 36 on the ink cartridges 17 are engaged with locked openings 37 in the carriage 10 (see FIG. 4), the energizing members 34 are members that upwardly energize the ink cartridges 17 and maintain the engaged state. If the engaged states of the engaging claws 36 with the locked openings 37 are released when the ink cartridges 17 are removed from the holder 19, the ink cartridges 17 are upwardly raised by the energizing force of the energizing members 34 such that the ink cartridges 17 can be easily removed. In the embodiment, two notches 33 are provided in the base plate 30 to correspond to the ink cartridge 17a and the ink cartridge 17b.

A total of four groove-shaped intermediate channels 39 (channel in joint surface) that extend along the surface direction as illustrated in FIG. 5 are formed for each color of ink in the upper surface of the channel plate 20 joined to the lower surface of the holder 19 (joint surface to the holder 19). Adhesives are applied to the peripheries of the intermediate channels 39, so that the opening portions of the intermediate channels 39 are sealed by the lower surface of the holder 19 to independently form the channels when the channel plate 20 is joined to the holder 19. One ends of intermediate channels 39 communicate with the ink introducing portions 31 of the holder 19, and similarly, the other ends penetrate the channel plate 20 in the thickness direction, are open on the lower surface of the channel plate 20 (surface on the head unit 22 side), and communicate with case channels 51 provided inside a case via channel connecting portions 53 of the head case 24 in the head unit 22 (see FIG. 8).

In addition, in a portion other than an area in which the intermediate channels 39 are formed on the upper surface of the channel plate 20, an atmosphere releasing groove 40 is formed in the upper surface of the channel plate 20, in a meandering manner. The atmosphere releasing groove 40 is a groove-shaped passage which is sufficiently narrower than the channel for ink, and configures a portion of the atmosphere releasing passage that communicates with the atmosphere. Also, a thin film 41 is joined to a portion in which the atmosphere releasing groove 40 is formed so that an opening exists on the upper portion of the groove is sealed. One end of the atmosphere releasing groove 40 communicates with the air. In addition, the other end of the atmosphere releasing groove 40 communicates with a compliance space 73 of the head unit 22 via an area in which the intermediate channels 39 are formed (joint space described below), a through hole (not illustrated) that penetrates the channel plate 20, and an atmosphere releasing and communicating passage 52 (described below). The atmosphere releasing groove 40 has a fixed passage cross-sectional area and a total length such that the passing of moisture (vapor) there through is hindered, in other words, the passing of moisture is resisted. Accordingly, the passing of the moisture in the recording head 3 through the atmosphere releasing passage can be suppressed and the moisture can be released to the atmosphere. Also, adhesives are applied so that an area in which the intermediate channels 39 and the atmosphere releasing groove 40 are formed can be surrounded. When the channel plate 20 is joined to the holder 19, the area is sealed by the lower surface of the holder 19, and thus the joint space that includes the intermediate channels 39 and the atmosphere releasing groove 40 are formed.

The circuit substrate 21 is provided between the channel plate 20 and the head case 24 of the head unit 22. The circuit substrate 21 is a substrate that relays a driving signal sent from the main body of the printer to a piezoelectric element 48, or other control signals. In the circuit substrate 21, a terminal portion (not illustrated) that is electrically connected to a terminal portion of a flexible cable 50 described below is formed, and also a connector 43, other electric components, and the like for the connection to the main body of the printer are mounted. A flexible flat cable (FFC: corresponding to wiring relating to driving of ink jet head according to the invention) 44 is connected to the connector 43 (see FIG. 2), and the circuit substrate 21 receives driving signals from the main body of the printer via the FFC 44. In a state in which the circuit substrate 21 is installed in the recording head 3 and the recording head 3 is fixed to the carriage 10, the connector 43 is arranged in a storage space S on the opposite side of the sidewall 7′ on one end side of the body frame 7 in the carriage scanning direction, in the carriage 10 (see FIG. 3).

In addition, as illustrated in FIG. 5, a substrate opening 45 that penetrates the circuit substrate 21 in the plate thickness direction is formed in the circuit substrate 21. The substrate opening 45 is a clearance hole. The other end of the flexible cable 50 of which one end is connected to the piezoelectric element 48 and which is extracted from a hollow storage portion 47 of the head case 24 is inserted through the substrate opening 45 (see FIG. 8). Also, the channel connecting portions 53 which are upstream ends of the case channels 51 of the head case 24 are inserted through the substrate opening 45. When the head case 24 and the channel plate 20 are joined together in a state in which the circuit substrate 21 is interposed therebetween, the channel connecting portions 53 of the head case 24 are inserted to the substrate opening 45 of the circuit substrate 21, and connected to the intermediate channels 39 of the channel plate 20. In addition, the atmosphere releasing groove 40 of the channel plate 20 is also connected to the atmosphere releasing and communicating passage 52 described below via the substrate opening 45.

The head case 24 is a member manufactured mainly of a synthetic resin such as an epoxy-based resin. The head case 24 according to the embodiment includes a case main body portion 24a to which the channel unit 25 is joined, on the lower side, and a flange portion 24b on the upper side of the case main body portion 24a. A portion to which the channel unit 25 is joined in the case main body portion 24a is, for example, manufactured of metal such as stainless steel. In addition, the dimension of the flange portion 24b in a direction orthogonal to the nozzle array direction (carriage scanning direction) is set to be greater than the dimension of the case main body portion 24a in the scanning direction. The hollow storage portions 47 for storing the oscillator unit 23 are formed inside the head case 24 in a state of penetrating the head case 24 in the thickness direction.

In addition, in the head case 24, at a position deviated to the outer side of the hollow storage portions 47 in the carriage scanning direction, the case channels 51 are formed in a state of penetrating the head case 24 in the thickness direction. The upstream ends of the case channels 51 are open to the channel connecting portions 53 formed on the upper surface of the head case 24 (upper surface of the flange portion 24b), and communicate with the intermediate channels 39 of the channel plate 20. In addition, the downstream ends of the case channels 51 are open on the lower surface of the head case 24 (lower surface of the case main body portion 24a), and communicate with the common liquid chamber 59 in the channel unit 25. Further, in the head case 24, at a position deviated from the case channels 51 in a nozzle array direction, the atmosphere releasing and communicating passage 52 is formed. The atmosphere releasing and communicating passage 52 is a passage that configures a portion of the atmosphere releasing passage, and one end thereof is open on the upper surface of the head case 24, and communicates with the atmosphere releasing groove 40 of the channel plate 20 through the through hole. In addition, the downstream end of the atmosphere releasing and communicating passage 52 is open on the lower surface of the head case 24 and communicates with the compliance space 73.

The oscillator unit 23 includes the piezoelectric element 48 that functions as a kind of actuator, a fixing plate 49 to which the piezoelectric element 48 is joined, and the flexible cable 50 for supplying driving signals to the piezoelectric element 48. The piezoelectric element 48 is a piezoelectric element of a layered type which is obtained by cutting a piezoelectric plate in which piezoelectric body layers and electrode layers are alternately stacked into a comb teeth shape, and a piezoelectric element in a longitudinal vibration mode that is extendible in a direction orthogonal to a layered direction (electric field direction) (a horizontal field effect-type piezoelectric element).

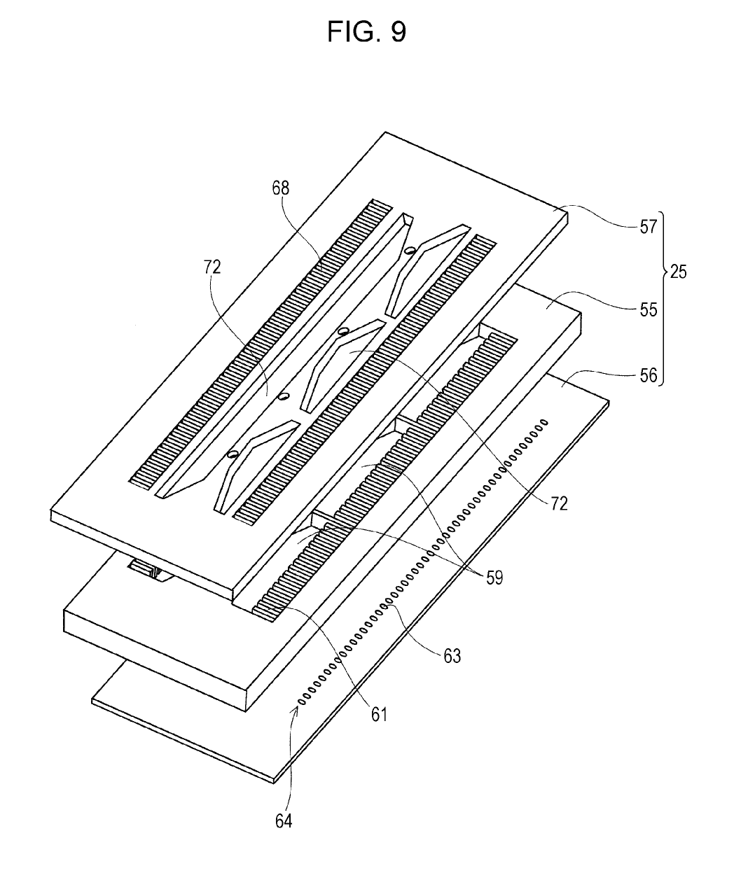

FIG. 9 is an exploded perspective view illustrating a configuration of the channel unit 25. The channel unit 25 is configured by joining a nozzle substrate 56 to one surface of a channel substrate 55 and a vibration plate 57 to the other surface the channel substrate 55. That is, the channel substrate 55, the nozzle substrate 56, and the vibration plate 57 are channel unit configuration members (components). A common liquid chamber 59 (reservoir), an ink supply port 60, a pressure chamber 61, a nozzle communication opening 62, and the nozzles 63 are provided in the channel unit 25. Also, a series of ink channels from the ink supply port 60 to the nozzles 63 via the pressure chamber 61 and the nozzle communication opening 62 are formed to correspond to respective nozzles 63. In addition, the channel unit configuration members all are configured with plates which are long in the nozzle direction.

The nozzle substrate 56 positioned on the lowest layer among the channel unit configuration members is a plate material in which the plurality of nozzles 63 are bored at a pitch (for example, 180 dpi) corresponding to the density of formed dots. As the material of the nozzle substrate 56, metal plates such as stainless steel or a silicon single crystal substrate used in the same manner as in the channel substrate 55 described below can be employed. Two nozzle arrays 64 (nozzle groups) obtained by arranging the plurality of nozzles 63 are arranged in the nozzle substrate 56, and one of the nozzle arrays 64 is, for example, configured with 180 nozzles 63. The lower surface of the nozzle substrate 56 (surface on which ink is ejected from the nozzles 63) is a nozzle surface. In addition, the number of the nozzle arrays 64 formed on the nozzle substrate 56 and the number and pitches of the nozzles 63 that configure the nozzle arrays 64 are not limited to the values exemplified in the embodiment, and various configurations can be employed.

The vibration plate 57 which is the upper most layer among the channel unit configuration members has a double structure in which an elastic film 67 is layered on the surface of a supporting substrate 66. In the embodiment, the vibration plate 57 is configured of a composite board in which a metal plate such as stainless steel is laminated as the supporting substrate 66, and a resin film is laminated as the elastic film 67 on the surface of the supporting substrate 66. On the vibration plate 57, a diaphragm 68 that changes the volume of the pressure chamber 61 is provided. The diaphragm 68 is manufactured by partially removing the supporting substrate 66 through etching processing or the like. That is, the diaphragm 68 is formed of the island portion 69 to which a front end surface of a free end portion of the piezoelectric element 48 is joined, and a flexible portion 70 which is provided around the island portion 69. The front end surface of the piezoelectric element 48 is joined to the island portion 69. Also, if the free end portion of the piezoelectric element 48 is expanded and contracted, the diaphragm 68 is displaced so that the volume of the pressure chamber 61 can be changed.

In addition, in the vibration plate 57, at a portion corresponding to the common liquid chamber 59 of the channel substrate 55, a compliance portion 72 that seals the common liquid chamber 59 is provided. The compliance portion 72 can be manufactured by removing a supporting substrate 31 in an area that faces an aperture of the common liquid chamber 59 through etching processing or the like, so that only the elastic film 67 remains in the corresponding portion. Also, the compliance portion 72 functions as a damper that absorbs the pressure fluctuations in the liquid accumulated in the common liquid chamber 59. If the channel unit 25 is joined to the lower surface of the head case 24, the upper opening of the compliance portion 72 (opening on the head case 24 side) is sealed by the lower surface of the head case 24 so that the compliance space 73 is defined. The lower end of the atmosphere releasing and communicating passage 52 of the head case 24 communicates with the compliance space 73. That is, the compliance space 73 communicates with the atmosphere via the atmosphere releasing and communicating passage 52 and the atmosphere releasing groove 40. In addition, in the vibration plate 57, the supporting substrate 66 is joined to the head case 24, so that the elastic film 67 is joined to the channel substrate 55.

The channel substrate 55 according to the embodiment is a plate-shaped member in which hollow portions that partition ink channels, specifically, a hollow portion that becomes the common liquid chamber 59, a hollow portion that becomes the ink supply port 60, and hollow portion that becomes the pressure chamber 61 (hereinafter, the hollow portions are simply referred to as the common liquid chamber 59, the ink supply port 60, and the pressure chamber 61, respectively) are partitioned and formed. The channel substrate 55 is manufactured, for example, by performing anisotropic etching processing on a silicon wafer which is a kind of a crystalline substrate.

With respect to the dimensions of configuration members of the recording head 3 in the direction orthogonal to the nozzle array (carriage scanning direction), dimensions of the channel plate 20 and the holder 19 in the scanning direction are set to be greater than a dimension of the head unit 22 in the scanning direction as illustrated in FIG. 7. In addition, with respect to a central line C′ of the channel plate 20 and the holder 19 in the carriage scanning direction (lateral direction in FIG. 7), a central line Ch of the head unit 22 in the carriage scanning direction is deviated to one side in the scanning direction (in a state of being mounted to the carriage 10, the sidewall 7′ on one end side of the body frame 7). The central line Ch of the head unit 22 is a virtual line that passes through the center of the nozzle substrate 56 in the carriage scanning direction. Here, the center of the recording head 3 in the carriage scanning direction means a position corresponding to the central line Ch.

Subsequently, the carriage 10 to which the recording head 3 is mounted is described.

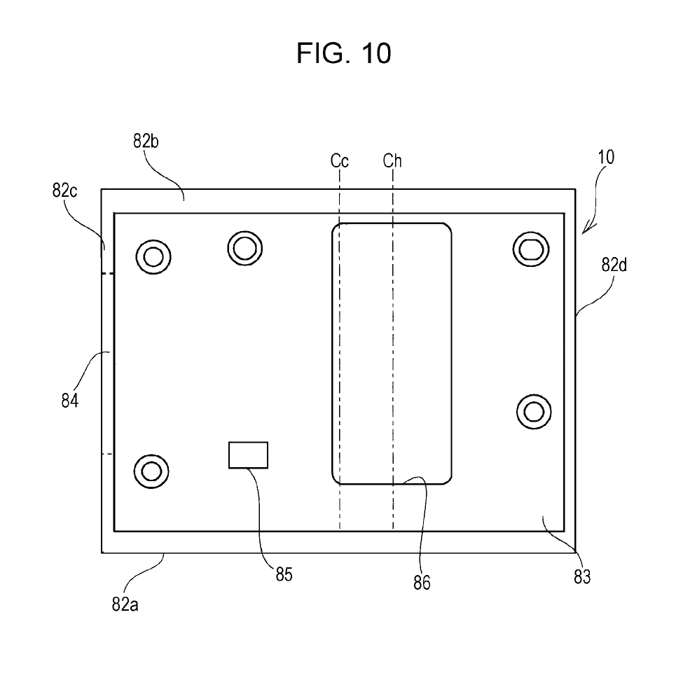

FIG. 10 is a plan view illustrating a configuration of the carriage 10. The carriage 10 according to the embodiment includes a front side wall 82a, a rear side wall 82b, both side walls 82c and 82d, and a bottom plate 83. That is, the carriage 10 is a upper surface opened box-shaped member in which the front side wall 82a, the rear side wall 82b, and the both side walls 82c and 82d stand from the periphery of the bottom plate 83. Among them, the recording head 3 and a paper width sensor 85 are installed on the bottom plate 83. As illustrated in FIG. 3, the paper width sensor 85 (corresponding to detection apparatus in the invention) includes an element portion 85a formed of a light emitting element and a light receiving element (not illustrated) and a substrate portion 85b related to the driving of the element portion 85a. In addition, in a state in which the element portion 85a is inserted to a through hole which is open to the bottom plate 83 and exposed to the lower surface of the carriage 10 (lower surface of the bottom plate 83), the substrate portion 85b is mounted on the upper surface of the bottom plate 83. The paper width sensor 85 detects the width of recording paper on the platen 9 by irradiating the platen 9 from the light emitting element with light and receiving reflected light from the platen 9. As illustrated in FIG. 3, the paper width sensor 85 is arranged in the storage space S, which is on a side of the recording head 3 arranged in the carriage 10 and on the opposite side of the sidewall 7′ on one end side of the body frame 7 in the carriage scanning direction. In addition, on the side wall 82c, a wiring opening 84 into which wiring connected to the paper width sensor 85 or the connector 43 of the recording head 3 is inserted is formed.

A rectangular insertion opening 86 is formed on the bottom plate 83 of the carriage 10. The opening shape of the insertion opening 86 has a shape that follows the external form of the head unit 22 in the plan view. The insertion opening 86 is formed to be deviated to one end side in the scanning direction, that is, on a side close to the sidewall 7′ on one end side of the body frame 7 with respect to a central line Cc of the carriage 10 in the carriage scanning direction (lateral direction in FIG. 10). Also, when the recording head 3 is arranged on the carriage 10, the head unit 22 is inserted from the upper side of the bottom plate 83 into the insertion opening 86 to be exposed to the lower side of the bottom plate 83. That is, the external form of the insertion opening 86 is set to be slightly greater in size than the external form of the head unit 22 in the plan view, and smaller than the external form of the flange portion 24b of the head case 24 in the plan view. Accordingly, when the recording head 3 is arranged in a space inside the carriage 10, the head unit 22 is exposed to an external side (lower surface side) of the carriage 10 via the insertion opening 86. Meanwhile, since the flange portion 24b of the head case 24 cannot pass through the insertion opening 86, the flange portion 24b is seated on the upper surface of the bottom plate 83. In this state, the recording head 3 is deviated to one end side in the scanning direction from the center of the carriage 10 in the scanning direction. That is, as illustrated in FIG. 3, the central line Ch of the recording head 3 in the scanning direction is deviated to one end in the scanning direction (the sidewall 7′ side on one end of the body frame 7) with respect to the central line Cc in the carriage scanning direction (lateral direction in FIG. 3). Accordingly, in the carriage 10, the storage space S is formed laterally on the other end side of the recording head 3. The storage space S means both a lateral space of the recording head 3 inside the carriage 10 (upper surface side of the bottom plate 83) and a lateral space of the recording head 3 on the bottom surface side of the carriage 10 (lateral side of the head unit 22 exposed to the bottom surface of the carriage 10).

In this manner, if the recording head 3 is deviated to the carriage 10 on one side in the scanning direction, narrow areas (dead spaces) respectively generated on both sides of the recording head in the carriage in the related art can be set to be one united space (the storage space S) on the lateral side at the other end of the recording head 3 so that the storage space S can be effectively used, for example, by arranging another member in the storage space S. In addition, if the recording head 3 is deviated to the carriage 10, other members such as the platen 9, the capping mechanism 13, and the wiping mechanism 14 can be entirely deviated to one end in the carriage scanning direction so as to contribute to the miniaturization of the whole body of the printer. According to the embodiment, if the capping mechanism 13 is arranged at a position that faces the nozzle surface of the recording head 3 positioned at a home position, dead spaces generated on one end side of the capping mechanism 13 can be reduced further than those in the related art.

In addition, according to the embodiment, if the recording head 3 is deviated to the carriage 10 so that a component that is concerned to intervene with the recording head 3, that is, the driving component 12 according to the embodiment, is arranged on the other end side in a main scanning direction, at least a portion of the corresponding component in a state in which the recording head 3 is positioned on the other end side can enter the storage space S on the lateral side of the recording head 3, the storage space S can be effectively used. Accordingly, the deviation can contribute to the further miniaturization of the printer 1.

Further, if the paper width sensor 85 is arranged in the storage space S, the space for arranging the paper width sensor 85 may not be separately provided, and the arrangement can contribute to the miniaturization of the printer 1. In addition, if the connector 43 that relatively largely occupies the internal space of the printer 1 is arranged in the storage space S, further miniaturization of the printer 1 becomes possible.

In addition, according to the embodiment, as an actuator of the invention, a so-called longitudinal vibration-type piezoelectric element is exemplified, but the invention is not limited thereto, and other actuators such as a so-called electrostatic actuator that causes a portion of the pressure chamber to be deviated by the electrostatic force or a heat generating element that causes the pressure fluctuation in the pressure chamber due to bubbles generated in liquid by heating can be employed.

Also, in the above, as the ink jet printer, the printer 1 in which the recording head 3 which is a kind of the ink jet head is mounted on the carriage 10 is described as an example, but the invention is not limited thereto, and the invention can be applied to another printer in which an ink jet head configured by combining plural configuration members in a state in which the positions thereof are determined is mounted to a member corresponding to a carriage. For example, the invention can be applied to a display manufacturing printer to which a coloring material ejecting head is mounted in order to manufacture a color filter such as a liquid crystal display or the like or an electrode manufacturing printer to which an electrode material ejecting head that forms electrodes such as organic electro luminescence (EL) display or field emission display (FED) is mounted.

What is claimed is:

1. An ink jet printer comprising:
an ink jet head that has a nozzle surface on which nozzles for ejecting liquid are open; and
a carriage on which the ink jet head is mounted,
wherein the carriage is scanned from which a scanning reference point, at a home position within a movement range of the carriage, to an end side of the movement range of the carriage within the movement range of the carriage via an area through which a liquid impacted object passes,
wherein the ink jet head is mounted to the carriage in a state of being deviated to the home position in a scanning direction from a center of the carriage in the scanning direction, and
wherein a space is provided on an opposite side to the ink jet head deviated relative to the carriage,
wherein at least a portion of a component of a mechanism relating to transportation of the impacted object is arranged in the space.

2. An ink jet printer comprising:
an ink jet head that has a nozzle surface on which nozzles for ejecting liquid are open; and
a carriage on which the ink jet head is mounted,
wherein the carriage is scanned from which a scanning reference point, at a home position within a movement range of the carriage, to an end side of the movement range of the carriage within the movement range of the carriage via an area through which a liquid impacted object passes,
wherein the ink jet head is mounted to the carriage in a state of being deviated to the home position in a scanning direction from a center of the carriage in the scanning direction, and
wherein a space is provided on an opposite side to the ink jet head deviated relative to the carriage,
wherein a detection apparatus that detects an end portion of the impacted object is arranged in the space.

3. An ink jet printer comprising:
an ink jet head that has a nozzle surface on which nozzles for ejecting liquid are open; and
a carriage on which the ink jet head is mounted,
wherein the carriage is scanned from which a scanning reference point, at a home position within a movement range of the carriage, to an end side of the movement range of the carriage within the movement range of the carriage via an area through which a liquid impacted object passes,
wherein the ink jet head is mounted to the carriage in a state of being deviated to the home position in a scanning direction from a center of the carriage in the scanning direction, and
wherein a space is provided on an opposite side to the ink jet head deviated relative to the carriage,
wherein a connector to which wiring relating to driving of the ink jet head is connected is arranged in the space.

4. The ink jet printer according to claim 1, wherein a maintenance mechanism that performs maintenance of the ink jet head is arranged at a position that faces a nozzle surface of the ink jet head positioned at the scanning reference point.

5. The ink jet printer according to claim 2, wherein a maintenance mechanism that performs maintenance of the ink jet head is arranged at a position that faces a nozzle surface of the ink jet head positioned at the scanning reference point.

6. The ink jet printer according to claim 3, wherein a maintenance mechanism that performs maintenance of the ink jet head is arranged at a position that faces a nozzle surface of the ink jet head positioned at the scanning reference point.
